(19) United States
(12) Patent Application Publication
(10) Pub. No.: US 2017/0154292 A1
(43) Pub. Date: Jun. 1, 2017

(54) SYSTEM AND METHOD FOR MANAGING RESOLUTION OF AN INCIDENT TICKET

(71) Applicant: Wipro Limited, Bangalore (IN)

(72) Inventor: Arthi Venkataraman, Bangalore (IN)

(21) Appl. No.: 14/994,869

(22) Filed: Jan. 13, 2016

(30) Foreign Application Priority Data
Nov. 26, 2015 (IN) 6358/CHE/2016

(51) Int. Cl. G06Q 10/06; G06Q 30/00

(52) U.S. Cl. CPC G06Q 10/06393; G06Q 10/063114; G06Q 30/016

(57) ABSTRACT

This disclosure relates generally to incident management, and more particularly to system and method for managing resolution of an incident ticket. In one embodiment, an incident management device for managing resolution of the incident ticket is disclosed. The incident management device comprises a processor and a memory communicatively coupled to the processor. The memory stores processor instructions, which, on execution, causes the processor to identify an incident ticket state based on data associated with the incident ticket. The processor further determines one or more resolution performance indicators related to the incident ticket state and rates the incident ticket based on a rating for each resolution performance indicator of the one or more resolution performance indicators.

This application claims the benefit of Indian Patent Application Serial No. 6358/CHE/2015 filed Nov. 26, 2015, which is hereby incorporated by reference in its entirety.

### TECHNICAL FIELD

This disclosure relates generally to incident management, and more particularly to a system and method for managing resolution of an incident ticket.

### BACKGROUND

An incident management process aims at providing effective incident resolution to ensure quality of service provided to customers. The resolution of an incident ticket is influenced by a plurality of factors. The existing incident management process fail to provide a method for identifying the plurality of factors across lifecycle of the incident resolution.

Further, the quality of the incident resolution is assessed after the resolution of the incident ticket. As the assessment is after the resolution of the incident ticket, there does not exist a means for improving the incident resolution during the lifecycle of the incident resolution. Also, the quality of the incident resolution is assessed manually based on a feedback provided by a user. As the assessment is manual, the time consumed for the incident management process is high.

In addition, the existing incident management processes do not provide a quantitative measure of the quality of the incident resolution across the lifecycle of the incident resolution. As the assessment of the quality of the incident resolution is not quantitative, the outcome may not be precise or objective.

### SUMMARY

In one embodiment, a method for managing resolution of an incident ticket is disclosed. The method comprises identifying, by an incident management device, an incident ticket state based on data associated with the incident ticket. The method further comprises determining, by the incident management device, one or more resolution performance indicators related to the incident ticket state. The method further comprises rating, by the incident management device, the incident ticket based on a rating for each resolution performance indicator of the one or more resolution performance indicators.

In one embodiment, an incident management device for managing resolution of an incident ticket is disclosed. The incident management device comprises a processor and a memory communicatively coupled to the processor. The memory stores processor instructions, which, on execution, causes the processor to identify an incident ticket state based on data associated with the incident ticket. The processor further determines one or more resolution performance indicators related to the incident ticket state and rates the incident ticket based on a rating for each resolution performance indicator of the one or more resolution performance indicators.

It is to be understood that both the foregoing general description and the following detailed description are exemplary and explanatory only and are not restrictive of the technology, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary network implementation comprising an incident management device for managing resolution of an incident ticket according to some embodiments of the present disclosure.

FIG. 2 is a flow diagram illustrating a method for managing resolution of the incident ticket in accordance with some embodiments of the present disclosure.

FIG. 3 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

The present subject matter discloses a system and method for managing resolution of an incident ticket. The system and method may be implemented in a variety of computing systems. The computing systems that can implement the described method(s) include, but are not limited to a server, a desktop personal computer, a notebook or a portable computer, hand-held devices, and a mainframe computer. Although the description herein is with reference to certain computing systems, the system and method may be implemented in other computing systems, albeit with a few variations, as will be understood by a person skilled in the art.

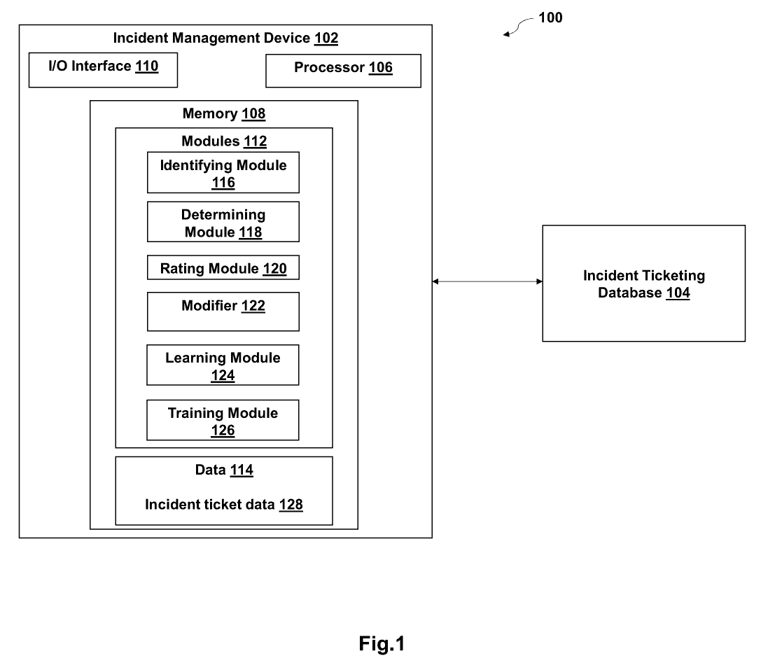

Working of the system and method for managing the resolution of the incident ticket is described in conjunction with FIGS. 1-3. It should be noted that the description and drawings merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and are to be construed as being without limitation to such specifically recited examples and conditions. Moreover, all statements herein reciting principles, aspects, and embodiments of the present subject matter, as well as specific examples thereof, are intended to encompass equivalents thereof. While aspects of the systems and methods can be implemented in any number of different computing systems environments, and/or configurations, the embodiments are described in the context of the following exemplary system architecture(s).

FIG. 1 illustrates an exemplary network implementation 100 comprising an incident management device 102 for managing resolution of an incident ticket according to some embodiments of the present disclosure. As shown in the FIG. 1, the incident management device 102 is communicatively coupled to an incident ticketing database 104. In one implementation, the incident ticketing database 104 may be present within the incident management device 102.

The incident ticketing database 104 may comprise one or more incident tickets. The one or more incident tickets may be open incident tickets, pending incident tickets, closed incident tickets, or resolved incident tickets.

The incident management device 102 may be communicatively coupled to the incident ticketing database 104 through a network. The network may be a wireless network, wired network or a combination thereof. The network can be implemented as one of the different types of networks, such as intranet, local area network (LAN), wide area network (WAN), the internet, and such. The network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network may include a variety of network devices, including routers, bridges, servers, computing devices, storage devices, etc.

As shown in the FIG. 1, the incident management device 102 comprises a processor 106, a memory 108 coupled to the processor 106, and input/output (I/O) interface(s) 110. The processor 106 may be implemented as one or more microprocessors, microcomputers, microcontrollers, digital signal processors, central processing units, state machines, logic circuitries, and/or any devices that manipulate signals based on operational instructions. Among other capabilities, the processor 106 is configured to fetch and execute computer-readable instructions stored in the memory 108. The memory 108 can include any non-transitory computer-readable medium known in the art including, for example, volatile memory (e.g., RAM), and/or non-volatile memory (e.g., EPROM, flash memory, etc.).

The I/O interface(s) 110 may include a variety of software and hardware interfaces, for example, a web interface, a graphical user interface, etc., allowing the incident management device 102 to interact with user devices, and the incident ticketing database 104. Further, the I/O interface(s) 110 may enable the incident management device 102 to communicate with other computing devices. The I/O interface(s) 110 can facilitate multiple communications within a wide variety of networks and protocol types, including wired networks, for example LAN, cable, etc., and wireless networks such as WLAN, cellular, or satellite. The I/O interface(s) 110 may include one or more ports for connecting a number of devices to each other or to another server.

In one implementation, the memory 108 includes modules 112 and data 114. In one example, the modules 112, amongst other things, include routines, programs, objects, components, and data structures, which perform particular tasks or implement particular abstract data types. The modules 112 and may also be implemented as, signal processor(s), state machine(s), logic circuitries, and/or any other device or component that manipulate signals based on operational instructions. Further, the modules 112 can be implemented by one or more hardware components, by computer-readable instructions executed by a processing unit, or by a combination thereof.

In one implementation, the data 114 serves, amongst other things, as a repository for storing data fetched, processed, received and generated by one or more of the modules 112. In one implementation, the data 114 may include incident ticket data 128 (data associated with the incident ticket). In one embodiment, the data 114 may be stored in the memory 108 in the form of various data structures. Additionally, the aforementioned data can be organized using data models, such as relational or hierarchical data models. In an example, the data 114 may also comprise other data used to store data, including temporary data and temporary files, generated by the modules 112 for performing the various functions of the incident management device 102.

In one implementation, the modules 112 further include an identifying module 116, a determining module 118, a rating module 120, a modifier 122, a learning module 124, and a training module 126. In an example, the modules 112 may also comprises other modules. The other modules may perform various miscellaneous functionalities of the incident management device 102. It will be appreciated that such aforementioned modules may be represented as a single module or a combination of different modules.

In order to manage the resolution of the incident ticket, the identifying module 116 may identify the incident ticket state based on the data associated with the incident ticket. The data associated with the incident ticket may be alternatively referred to as the incident ticket data 128. The incident ticket data 128 may include, but are not limited to, the incident ticket state, time related data, user-agent interaction data, agent performance data, and incident ticket category. The incident ticket state may include, but not limited to, ticket raised but not assigned to an agent, ticket raised and assigned to the agent but not processed, ticket being processed and pending with the agent, ticket being processed and pending with a user, ticket being processed but is on hold, or the like.

The time related data may include time at which the incident ticket is raised, the time at which the agent is assigned to the incident ticket, the time at which the incident ticket state is updated, the time at which the incident ticket is categorized, the time at which the incident ticket is updated, the time at which the incident ticket is resolved, the time at which the incident ticket is closed, and the like. The user-agent interaction data may include a request or a query from a user, public comments, agent response, and the like.

Further, the incident ticket may be categorized into an incident ticket category based on an issue raised in the incident ticket by the user. For example, if the issue is, “wireless network not working”, then the incident ticket may be categorized as “network problem”. In another example, if the issue is, “error in software installation”, then the incident ticket may be categorized as ‘software’.

The agent performance data may include number of incident tickets assigned to an agent for the incident ticket category, number of incident tickets resolved by the agent in the incident ticket category, number of high priority incident tickets resolved by the agent, number of high severity incident tickets resolved by the agent, number of incident tickets transferred to another agent within same incident ticket category, number of incident tickets transferred from another agent within same incident ticket category, number of incident tickets closed by the agent which were subsequently re-opened, time taken for closing the incident ticket in an incident ticket category, user rating for each incident ticket closed by the agent, or the like. The agent performance data may also include number of incident tickets closed by the agent before average closure time for an incident ticket category. For example, if the average closure time for an incident ticket category is ‘one hour’, then the number of incident tickets which are closed within an hour may be included in the agent performance data. Similarly, the agent performance data may also include number of incident tickets closed by the agent after average closure time for the incident ticket category. For example, if the average closure time for an incident ticket category is “two hours”, then the number of tickets which consume more than “two hours” to close may be included in the agent performance data.

After identifying the incident ticket state, the determining module 118 may determine one or more resolution performance indicators related to the incident ticket state. The one or more resolution performance indicators may comprise timeliness of response, user-agent interaction, agent performance, and incident categorization accuracy.

In some implementations, if the incident ticket state is, ‘ticket raised but not assigned to an agent’, the one or more resolution performance indicators related to the incident ticket state may be the timeliness of response and the incident categorization accuracy. As the timeliness of response may be determined based on the time at which the incident ticket is raised, the timeliness of response may be related to the incident ticket state. Similarly, the incident ticket may be categorized immediately after the incident ticket is raised and before an agent is assigned. Thus, the incident categorization accuracy may be related to the incident ticket state. On the other hand, as the incident ticket is not assigned to an agent, the user-agent interaction and the agent performance may not be related to the incident ticket state.

In order to manage the resolution of the incident ticket, the determining module 118 may determine the timeliness of response and the incident categorization accuracy. The timeliness of response may be determined based on time consumed in the incident ticket state and expected processing time for the incident ticket state. The timeliness of response may also include timeliness of an action performed at the incident ticket state. For example, if the incident ticket state is “ticket raised but not assigned to an agent”, the timeliness of response may correspond to the timeliness of the action performed at the incident ticket state. The action may include assigning an agent for the incident ticket.

In some implementations, the timeliness of response may be determined by computing a difference between the time consumed in the incident ticket state and the expected processing time for the incident ticket state. The time consumed in the incident ticket state may be determined based on a difference between the time at which the incident ticket state is updated to a current incident ticket state and the current time. The expected processing time for the incident ticket state may be predefined for an incident ticket category. The expected processing time for the incident ticket state, for the incident ticket category may be retrieved from the incident ticket database 104.

After determining the timeliness of response, the rating module 120 may compute a rating for the timeliness of response. The rating of the timeliness of response may be represented by a timeliness score. The timeliness of response may be normalized to compute the timeliness score. Further, the timeliness score may vary between ‘0’ and ‘1’. The timeliness score of ‘1’ may indicate maximum adherence to expected timeliness of response and the timeliness score of ‘0’ may indicate least adherence to the expected timeliness of response.

In addition to determining the timeliness of response, the determining module 118 may determine the incident categorization accuracy for the category under which the incident ticket has been placed. The incident categorization accuracy may be determined based on a historical model automatically built by comparing an incident ticket category in which the incident ticket is raised and an incident ticket category in which the incident ticket is closed. The incident categorization accuracy may be computed for a particular category based on number of incident tickets closed in that category, number of incident tickets categorized correctly, and number of incident tickets categorized incorrectly. For example, if the incident ticket category of the incident ticket is ‘hardware’, then the incident categorization accuracy is determined for the incident ticket category ‘hardware’ based on historical data of the incident tickets closed in the incident ticket category. Further, if the incident ticket category for the incident ticket is ‘hardware’ when the incident ticket is raised and the incident ticket category for the incident ticket is ‘hardware’ when the incident ticket is closed, then the incident ticket is categorized correctly. On the other hand, if the incident ticket category for the incident ticket is ‘software’ when the incident ticket is raised and the incident ticket category for the incident ticket is ‘hardware’ when the incident ticket is closed, then the incident ticket is categorized incorrectly. An incorrectly categorized incident ticket may lower the incident categorization accuracy.

Upon determining the incident categorization accuracy, the rating module 120 may compute a rating for the incident categorization accuracy. The rating of the incident categorization accuracy may be represented by a categorization accuracy score. The incident categorization accuracy may be normalized to compute the categorization accuracy score. The categorization accuracy score may vary between ‘0’ and ‘1’.

After determining the one or more resolution performance indicators related to the incident ticket state, the rating module 120 may compute a rating of the incident ticket based on the rating for each resolution performance indicator. As the incident ticket state is, ‘ticket raised but not assigned an agent’, the one or more resolution performance indicators related to the incident ticket state may be the timeliness of response and the incident categorization accuracy. In order to compute the rating of the incident ticket, the rating module 120 may compute a weighted average of the timeliness score and the categorization accuracy score.

The cumulative rating of the one or more resolution performance indicators may enable the rating module 120 to predict the quality of the resolution of the incident ticket. The quality of the resolution may be predicted by based on a model built using a training database. The rating module 120 may provide the cumulative rating as an input to the model. The model may predict the quality of the resolution as one of ‘good’, ‘medium’, and ‘poor’ based on the cumulative rating. For example, if the cumulative rating is ‘0.7’, the model may predict the quality as ‘medium’. In another example, if the cumulative rating is below ‘0.5’, the model may predict the quality as ‘poor’.

In some implementations, the incident ticket state may be, ‘ticket being processed but pending with agent. The resolution performance indicators related to the incident ticket state may be the timeliness of response, the agent performance, the user-agent interaction, and the incident categorization accuracy. As the timeliness of response may be determined based on the time at which the incident ticket is raised, the timeliness of response may be related to the incident ticket state. Similarly, the incident ticket may be categorized immediately after the incident ticket is raised and before an agent is assigned. Thus, the incident categorization accuracy may be related to the incident ticket state.

Further, as the incident ticket is assigned to the agent, the agent performance may be related to the incident ticket state. Also, as the ticket is being processed the interaction between the user and the agent is initiated. Thus, the user-agent interaction may be related to the incident ticket state.

In order to manage the resolution of the incident ticket, the determining module 118 may determine the timeliness of response, the incident categorization accuracy, the user-agent interaction, and the agent performance. The user agent interaction may be determined based on the analysis of the user-agent interaction data available for the current incident ticket state. The user-agent interaction may be determined based on at least one of an agent response coherence and a user response sentiment. The agent response coherence may be determined based on relevancy of an agent response to the incident ticket. In order to determine the relevancy of the agent response to the incident ticket, the determining module 118 may extract intent of the incident ticket and intent of the agent response. The intent of the agent response and the intent of the incident ticket may be extracted by using a model trained on historical data. Further, the intent of the incident ticket and the intent of the agent response may be compared semantically. If the intent of the incident ticket and the intent of the agent response is identical, the agent response may be deemed coherent.

For example, if the incident ticket comprises a question, “How do I reset my password?”, the intent of the question may be determined as “Reset my password” by the determining module 118. Further, if the agent response to the question is “To reset the password you would need to log into account services and select Reset password”, then the intent of the agent response may be determined as “Reset the password”. Since the intent of the response is in line with the intent of the question or is coherent with the question, the agent response may be deemed coherent.

In another example, if the agent response to the question “How do I reset my password?” is “To connect to internet you would need to update your proxy password”, the intent of the agent response may be determined to be “Connect to internet.” As the intent of the agent response is not in line with the intent of the incident ticket, the agent response may be deemed non-coherent.

In addition to determining the agent response coherence, the determining module 118 may further determine the user response sentiment. The user response sentiment may be determined based on a user response to the incident ticket. To determine the response sentiment, a corpus may be maintained in the data 114 mapping particular phrases to one or more sentiments. The determining module 118 may match phrases present in the user response to phrases in the corpus to identify one or more sentiments associated with the user response. If a phrase from the user response does not match any phrases in the corpus, the sentiment for that phrase may be considered Neutral.

Further, a phrase may comprise terms which reverse the polarity of the phrase. The terms which reverse the polarity of the phrase are separately tracked. The phrases which comprise polarity inverters are evaluated for mapping of the sentiment based on pre-defined rules. For example, if the user response is “You are awesome.” The term ‘you’ may be considered as ‘neutral’, the term ‘are’ may be considered as ‘neutral’, and the term ‘awesome’ may be considered as ‘highly positive.’ Thus, the user response sentiment may be determined to be ‘highly positive.’ In another example, if the user response is ‘“You are not awesome.’” The term ‘you’ may be considered as ‘neutral’, the term ‘are’ may be considered as ‘neutral’, and the term ‘awesome’ may be considered as ‘highly positive.’ However, the user response comprises of the term ‘not’ which is a polarity inverter. Therefore, the user response sentiment may be considered to be ‘negative.’

In some implementations, the rating module 120 may compute a rating for the user-agent interaction. The rating of the user-agent interaction may be represented by an interaction score. The interaction score may be computed based on the agent response coherence and the user response sentiment. The rating module 120 may convert the agent response coherence to a coherence score. In one implementation, the coherence score may vary between ‘0’ and ‘1’. For example, if the agent response is deemed coherent, the coherence score may be determined as ‘1’. If the agent response is deemed non-coherent, the coherence score may be determined as ‘0’.

Similarly, the rating module 120 may convert the user response sentiment to a sentiment score. In one implementation, the sentiment score may vary between ‘0’ and ‘1’. For example, if the user response sentiment is highly positive, the sentiment score may be determined as ‘1’. If the user response sentiment is highly negative, the sentiment score may be determined as ‘0’. The user response sentiment may be normalized to the sentiment score with ‘1’ indicating highest satisfaction of the user. Further, the rating module 120 may compute a weighted average of the coherence score and the sentiment score to compute the interaction score. Thus, the interaction score may vary between ‘0’ and ‘1’.

In addition to determining the timeliness of response, the incident categorization accuracy, and the user-agent interaction, the determining module 118 may determine the agent performance. The agent performance may be determined based on least one of number of incident tickets assigned to the agent for the incident ticket category and number of incident tickets resolved by the agent.

In addition, the agent performance may be determined based on the number of incident tickets assigned to the agent for an incident ticket category, the number of incident tickets resolved by the agent in an incident ticket category, the number of high priority incident tickets resolved by the agent, the number of high severity incident tickets resolved by the agent, the number of incident tickets transferred to another agent within same incident ticket category, the number of incident tickets transferred from another agent within same incident ticket category, the number of incident tickets closed by the agent which were subsequently re-opened, the time taken for closing each incident ticket in the incident ticket category, the number of times the incident ticket is closed before average closure time for the incident ticket category, the number of times the incident ticket is closed after average closure time for the incident ticket category, and the user rating for each incident ticket closed by the agent.

In some implementations, the rating module 120 may compute a rating for the agent performance in a particular incident ticket category. The rating of the agent performance may be represented by an agent performance score. For example, if an agent ‘A’ has resolved incident tickets for the incident ticket category of ‘printer’ and for the incident ticket category of “hard disk”, then the agent performance score for the agent ‘A’ may be computed individually for the printer incident ticket category and for the hard disk incident ticket category. Further, the agent performance score may vary between ‘0’ and ‘1’. The agent performance score of ‘1’ may indicate a highly skilled agent whereas a lower skilled agent may be given a lower agent performance score for a particular incident ticket category.

After determining the one or more resolution performance indicators for the incident ticket state, the rating module 120 may compute a rating of the incident ticket based on the rating for each resolution performance indicator. As, the incident ticket state is, ‘ticket being processed and pending with agent’, the one or more resolution performance indicators related to the incident ticket state may be the timeliness of response, the agent performance, the incident categorization accuracy, and the user-agent interaction data. In order to compute the rating of the incident ticket, the rating module 120 may compute a weighted average of the timeliness score, the agent performance score, the categorization accuracy score, and the interaction score.

The cumulative rating of the one or more resolution performance indicators may enable the rating module 120 to predict the quality of the resolution of the incident ticket. The quality of the resolution may be predicted based on a model built using a training database. The rating module 120 may provide the cumulative rating as an input to the model. The model may predict the quality of the resolution as one of ‘good’, ‘medium’, and ‘poor’ based on the cumulative rating. For example, if the cumulative rating is ‘0.7’, the model may predict the quality as ‘medium’. In another example, if the cumulative rating is below ‘0.5’, the model may predict the quality as ‘poor’.

After the rating module 120 predicts the quality of the resolution, the modifier 122 may be enabled to perform a corrective action when the quality of the resolution may be predicted as ‘poor’. The modifier 122 may perform a corrective action when the rating of the incident ticket is less than the rating threshold value. For example, if the rating of the incident ticket is below ‘0.5’, the quality of incident resolution may be identified as ‘poor’. In order to modify or amend the quality of the incident resolution, the modifier 122 may identify a resolution performance indicator with lowest rating amongst the one or more resolution performance indicators. Further, the modifier 122 may perform a corrective action pre-defined for the resolution performance indicator with the lowest rating. For example, if the agent performance has the lowest rating, then another agent with a higher agent performance score may be assigned for the resolution of the incident ticket.

Similarly, if the timeliness of response has the lowest rating, then automatically an email may be sent to the agent assigned to the incident ticket to resolve the incident ticket.

In order to efficiently manage the resolution of the incident ticket, the learning module 124 may update the management of the incident ticket by comparing the rating of the incident ticket determined at the incident ticket state and a rating of the incident ticket determined after the resolution of the incident ticket. After the resolution of the incident ticket, the incident ticket may be evaluated to compute a rating of the incident ticket. If the rating of the incident ticket is below a threshold value, the incident ticket may be evaluated as ‘poor’ quality incident ticket. For the incident tickets with poor quality, the resolution performance indicator with the lowest rating may be identified to determine effect of the resolution performance indicator on the resolution at each incident ticket state.

Further, the rating of the resolution performance indicator with the lowest rating after the resolution may be compared with the rating of the resolution performance indicator at each incident ticket state. For example, the rating of timeliness of response may be lowest after the resolution. The rating of timeliness of response may be compared with the rating of timeliness of response at each incident ticket state. If the rating of the timeliness of response after resolution is lesser than the rating of the timeliness of response at the incident ticket state, a weight assigned to the timeliness of response may be increased. The increase in the weight may indicate that the quality of the resolution is affected by the timeliness of response at the incident ticket state. The weight assigned to other resolution performance indicators at the incident ticket state may be decreased to indicate that the other resolution performance indicators may not affect the quality of the resolution performance indicators at the incident ticket state. The resolution performance indicators with updated weights may be fed to the training module 124. The training module 124 may provide the resolution performance indicators with updated weights to the incident management device 102. Further, the next computation of the rating of the incident ticket before the incident resolution may be based on the resolution performance indicators with updated weightages.

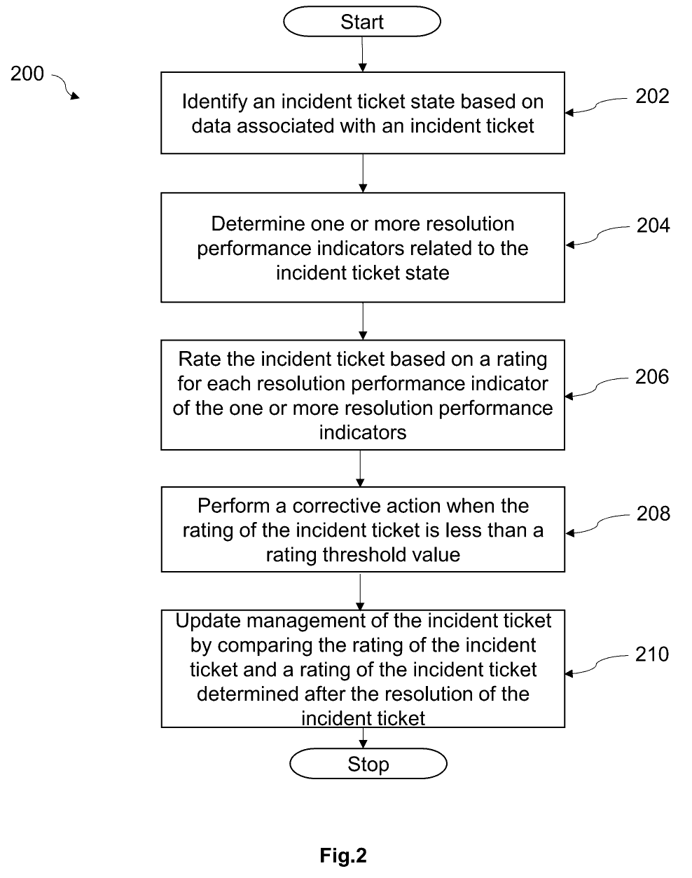

FIG. 2 is a flow diagram illustrating a method 200 for managing resolution of the incident ticket in accordance with some embodiments of the present disclosure.

The method 200 may be described in the general context of computer executable instructions. Generally, computer executable instructions can include routines, programs, objects, components, data structures, procedures, modules, and functions, which perform particular functions or implement particular abstract data types. The method 200 may also be practiced in a distributed computing environment where functions are performed by remote processing devices that are linked through a communication network. In a distributed computing environment, computer executable instructions may be located in both local and remote computer storage media, including memory storage devices.

The order in which the method 200 is described is not intended to be construed as a limitation, and any number of the described method blocks can be combined in any order to implement the method 200 or alternative methods. Additionally, individual blocks may be deleted from the method 200 without departing from the spirit and scope of the subject matter described herein. Furthermore, the method 200 can be implemented in any suitable hardware, software, firmware, or combination thereof.

With reference to the FIG. 2, at block 202, an incident ticket state may be identified based on data associated with an incident ticket. The identifying module 116 may identify the incident ticket state. The data associated with the incident ticket may include the incident ticket state, time related data, user-agent interaction data, agent performance data, and incident ticket category. The incident ticket state may include ticket raised but not assigned an agent, ticket raised and assigned an agent but not processed, ticket being processed and pending with the agent, ticket being processed and pending with a user, ticket being processed but is on hold, or the like. The identifying of the incident ticket state is explained in detail in conjunction with FIG. 1.

At block 204, one or more resolution performance indicators related to the incident ticket state may be determined. The determining module 118 may determine the one or more resolution performance indicators. The one or more resolution performance indicators may include timeliness of response, user-agent interaction, agent performance, and incident categorization accuracy. Determining the one or more resolution performance indicators is explained in detail in conjunction with FIG. 1.

At block 206, the incident ticket may be rated based on a rating for each resolution performance indicator of the one or more resolution performance indicators. The rating module 120 may rate the incident ticket based on a rating for each resolution performance indicator. In order to rate the incident ticket, the rating module 120 may compute a weighted average of a timeliness score, an interaction score, an agent performance score, and a categorization accuracy score. Rating the incident ticket is explained in detail in conjunction with FIG. 1.

At block 208, a corrective action may be performed when the rating of the incident ticket is less than a rating threshold value. The corrective action may be performed by a modifier 122. The modifier 122 may identify a resolution performance indicator with lowest rating amongst the one or more resolution performance parameters. Further, the modifier 122 may perform a corrective action pre-defined for the resolution performance indicator with the lowest rating. The performing of the corrective action is explained in detail in conjunction with the FIG. 1.

At block 210, the management of the incident ticket may be updated by comparing the rating of the incident ticket determined at the incident ticket state and a rating of the incident ticket determined after the resolution of the incident ticket. The learning module 124 may update the management of the incident ticket. The updating of the management of the incident ticket is explained in detail in conjunction with FIG. 1.

The incident management device 102 and the method disclosed herein manages the resolution of the incident ticket based on the resolution performance indicators determined at each stage of the resolution. The rating of the incident ticket is determined based on the resolution performance indicators. Thus, the incident management device 102 predicts the rating of the incident ticket before the resolution of the incident ticket based on data available at each incident ticket state. As the rating of the incident ticket post the resolution is predicted, the incident management device 102 may perform a corrective action based on the resolution performance indicator which affects the quality of the resolution the most. The corrective action modifies an action which is performed at the incident ticket state to resolve the incident ticket state, thereby improving the quality of the incident resolution.

Moreover, the resolution performance indicators comprises both qualitative and quantitative indicators for predicting the rating of the incident ticket. As the computation of the rating of the incident ticket is based on the qualitative and quantitative parameters, the prediction of rating of the incident ticket is objective and accurate.

In addition, the incident management device 102 and the method dynamically computes the rating of the incident ticket based on the user-agent interaction, the timeliness of response, the agent performance, and the incident categorization accuracy. Therefore, the time for managing the resolution of the incident resolution is reduced, thereby reducing overall time required for incident management.

### Computer System

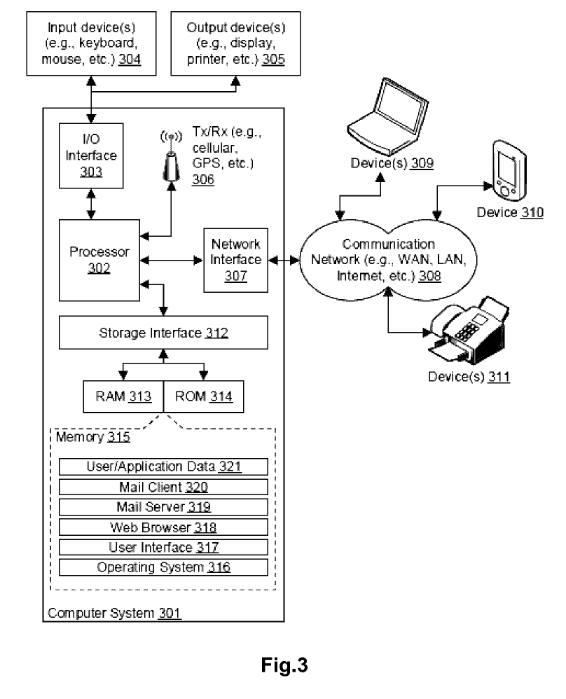

FIG. 3 is a block diagram of an exemplary computer system for implementing embodiments consistent with the present disclosure. Variations of computer system 301 may be used for implementing the identifying module 116, the determining module 118, the rating module 120, the modifier 122, the learning module 124, and the training module 126. Computer system 301 may comprise a central processing unit (“CPU” or “processor”) 302. Processor 302 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 302 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 302 may be disposed in communication with one or more input/output (I/O) devices via I/O interface 303. The I/O interface 303 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 303, the computer system 301 may communicate with one or more I/O devices. For example, the input device 304 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 305 may be a printer, fax machine, video display (e.g., cathode ray tube (CRT), liquid crystal display (LCD), light-emitting diode (LED), plasma, or the like), audio speaker, etc. In some embodiments, a transceiver 306 may be disposed in connection with the processor 302. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 302 may be disposed in communication with a communication network 308 via a network interface 307. The network interface 307 may communicate with the communication network 308. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 308 may include, without limitation, a direct interconnection, local area network (LAN), wide area network (WAN), wireless network (e.g., using Wireless Application Protocol), the Internet, etc. Using the network interface 307 and the communication network 308, the computer system 301 may communicate with devices 310, 311, and 312. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 301 may itself embody one or more of these devices.

In some embodiments, the processor 302 may be disposed in communication with one or more memory devices (e.g., RAM 313, ROM 314, etc.) via a storage interface 312. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 316, user interface application 317, web browser 318, mail server 319, mail client 320, user/application data 321 (e.g., any data variables or data records discussed in this disclosure), etc. The operating system 316 may facilitate resource management and operation of the computer system 301. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 317 may facilitate display, execution, interaction, manipulation, or operation of program components through textual or graphical facilities. For example, user interfaces may provide computer interaction interface elements on a display system operatively connected to the computer system 301, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 301 may implement a web browser 318 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 301 may implement a mail server 319 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 301 may implement a mail client 320 stored program component. The mail client may be a mail viewing application, such as Apple Mail, Microsoft Entourage, Microsoft Outlook, Mozilla Thunderbird, etc.

In some embodiments, computer system 301 may store user/application data 321, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described systems and methods for managing resolution of an incident ticket. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for managing resolution of an incident ticket, the method comprising:
identifying, by an incident management device, an incident ticket state based on data associated with the incident ticket;
determining, by the incident management device, one or more resolution performance indicators related to the incident ticket state; and
rating, by the incident management device, the incident ticket based on a rating for each resolution performance indicator of the one or more resolution performance indicators.

2. The method of claim 1, further comprising:
performing, by the incident management device, a corrective action when the rating of the incident ticket is less than a rating threshold value.

3. The method of claim 2, wherein the performing the corrective action comprises:
identifying, by the incident management device, a resolution performance indicator with lowest rating amongst the one or more resolution performance parameters; and
performing, by the incident management device, a corrective action pre-defined for the resolution performance indicator with the lowest rating.

4. The method of claim 1, wherein the one or more resolution performance indicators comprises a timeliness of response, a user-agent interaction, an agent performance, or an incident categorization accuracy.

5. The method of claim 4, wherein the timeliness of response is determined based on a time consumed in the incident ticket state and an expected processing time for the incident ticket state.

6. The method of claim 4, wherein the user-agent interaction is determined based on at least one of an agent response coherence or a user response sentiment.

7. The method of claim 6, wherein the agent response coherence is determined based on relevancy of an agent response to the incident ticket and the user response sentiment is determined based on a user response to the incident ticket.

8. The method of claim 4, wherein the agent performance is determined based on at least one of a number of incident tickets assigned to an agent for an incident ticket category or a number of incident tickets resolved by the agent.

9. The method of claim 4, wherein the incident categorization accuracy is determined based on a historical model automatically built by comparing an incident ticket category in which the incident ticket is raised and an incident ticket category in which the incident ticket is closed.

10. The method of claim 1, further comprising:
updating, by the incident management device, management of the incident ticket by comparing the rating of the incident ticket determined at the incident ticket state and a rating of the incident ticket determined after the resolution of the incident ticket.

11. An incident management computing device comprising a processor and a memory coupled to the processor which is configured to execute one or more programmed instructions comprising and stored in the memory to:
identify an incident ticket state based on data associated with the incident ticket;
determine one or more resolution performance indicators related to the incident ticket state; and
rate the incident ticket based on a rating for each resolution performance indicator of the one or more resolution performance indicators.

12. The incident management device of claim 11, wherein the processor coupled to the memory is further configured to execute at least one additional programmed instruction comprising and stored in the memory to:
perform a corrective action when the rating of the incident ticket is less than a rating threshold value.

13. The incident management device of claim 12, wherein the processor coupled to the memory is further configured to execute at least one additional programmed instruction comprising and stored in the memory to:
identify a resolution performance indicator with lowest rating amongst the one or more resolution performance parameters; and
perform a corrective action pre-defined for the resolution performance indicator with the lowest rating.

14. The incident management device of claim 11, wherein the one or more resolution performance indicators comprises a timeliness of response, a user-agent interaction, an agent performance, or an incident categorization accuracy.

15. The incident management device of claim 14, wherein the timeliness of response is determined based on a time consumed in the incident ticket state and an expected processing time for the incident ticket state.

16. The incident management device of claim 14, wherein the user-agent interaction is determined based on at least one of an agent response coherence or a user response sentiment.

17. The incident management device of claim 16, wherein the agent response coherence is determined based on relevancy of an agent response to the incident ticket and the user response sentiment is determined based on a user response to the incident ticket.

18. The incident management device of claim 14, wherein the agent performance is determined based on at least one of a number of incident tickets assigned to an agent for an incident ticket category or a number of incident tickets resolved by the agent.

19. The incident management device of claim 14, wherein the incident categorization accuracy is determined based on a historical model automatically built by comparing an incident ticket category in which the incident ticket is raised and an incident ticket category in which the incident ticket is closed.

20. The incident management device of claim 11, wherein the processor further:
update management of the incident ticket by comparing the rating of the incident ticket determined at the incident ticket state and a rating of the incident ticket determined after the resolution of the incident ticket.

21. A non-transitory computer readable medium having stored thereon instructions for managing resolution of an incident ticket comprising executable code which when executed by a processor, causes the processor to perform steps comprising:
identifying an incident ticket state based on data associated with the incident ticket;
determining one or more resolution performance indicators related to the incident ticket state; and
rating the incident ticket based on a rating for each resolution performance indicator of the one or more resolution performance indicators.
